(19) United States
(12) Patent Application Publication
(10) Pub. No.: US 2017/0198179 A1
(43) Pub. Date: Jul. 13, 2017

(54) BALL SEALERS FOR USE IN SUBTERRANEAN WELLS, METHODS OF MAKING AND USING SAME

(71) Applicant: RIVER CANYON INVESTMENTS, LLC, Houston, TX (US)

(72) Inventors: Scott Greenbauer, San Antonio, TX (US); Syed Akbar, Richmond, TX (US)

(73) Assignee: RIVER CANYON INVESTMENTS, LLC, Houston, TX (US)

(21) Appl. No.: 14/994,133

(22) Filed: Jan. 12, 2016

(51) Int. Cl. C09J 131/04; C08K 7/20; E21B 33/138; C09K 8/50

(52) U.S. Cl. CPC C09J 131/04; C09K 8/50; C08K 7/20; E21B 33/138; C09J 2205/11; E21B 43/261

(57) ABSTRACT

Low density water soluble ball sealers having a water soluble polymer phase, with one or more microspheres residing within the polymer phase, with these ball sealers suitable for use in well operations for sealing perforations in subterranean formations.

### RELATED APPLICATION DATA

Not applicable.

### BACKGROUND OF THE INVENTION

1. Field of the Invention

The present invention relates products for use in subterranean wells, and to methods of making and using such products. In another aspect, the present invention relates to ball sealers for use in subterranean wells, and to methods of making and using such ball sealers. In even another aspect, the present invention relates to ball sealers having micro spheres incorporated therein, and to methods of making and using such ball sealers. In still another aspect, the present invention relates to water soluble ball sealers that float in a well bore penetrating the subterranean, and to methods of making and using such ball sealers.

2. Description of the Related Art

It is common practice in completing oil and gas wells to set a string of pipe, known as casing, in the well and use cement around the outside of the casing to isolate the various formations penetrated by the well. To establish fluid communication between the hydrocarbon bearing formations and the interior of the casing, the casing and cement sheath are perforated.

At various times during the life of the well, it may be desirable to increase the production rate of hydrocarbons through acid treatment or hydraulic fracturing. If only a short, single pay zone in the well has been perforated, the treating fluid will flow into the pay zone where it is required. As the length of the perforated pay zone or the number of perforated pay zones increases, the placement of the fluid treatment in the regions of the pay zones where it is required becomes more difficult. For instances, the strata having the highest permeability will most likely consume the major portion of a given stimulation treatment leaving the least permeable strata virtually untreated. Therefore, techniques have been developed to divert the treating fluid from its path of least resistance so that the low permeability zones are also treated.

One technique for achieving diversion involves the use of downhole equipment such as packers. Although these devices are effective, they are quite expensive due to the involvement of associated workover equipment required during the tubing-packer manipulations. Additionally, mechanical reliability tends to decrease as the depth of the well increases.

As a result, considerable effort has been devoted to the development of alternative diverting methods. One of the most popular and widely used diverting techniques over the past 20 years has been the use of small rubber-coated balls, known as ball sealers, to seal off the perforations inside the casing.

Perforation ball sealers are defined in Schlumberger's oilfield glossary as “small spheres designed to seal perforations that are accepting the most fluid, thereby diverting reservoir treatments to other portions of the target zone.” Ball sealers and solid-particle agents are one of the most economical types of diverting materials used instead of costly packer system often requiring a rig.

Charles Simmons was the first known inventor to use ball sealers in a well, when in the fall of 1954 Charles ran into a problem: he wanted to fracture well casing selectively, but at the time no such process existed. So Charles hollowed out 40 rubber balls used to play jacks, filled each with a marble, and pumped them into a well to seal perforations in the well casing. Recalling the experiment, Charles said, “those first jack balls and marbles came from the dime store in Borger, Texas.” Charles' pioneering technique is still being used around the world to extract oil and gas from reluctant rocks. See, Charles M. Simmons Endowed Presidential Fellowship in Engineering, http://endowments.giving.utexas.edu/page/simmons-charles-epf-engr/5543/.

These ball sealers are pumped into the wellbore along with the formation treating fluid. The balls are carried down the wellbore and on to the perforations by the flow of the fluid through the perforations into the formation. The balls seat upon the perforations and are held there by the pressure differential across the perforation.

The major advantages of utilizing ball sealers as a diverting agent are: easy to use, positive shutoff, independent of the formation, and non-damaging to the well. The ball sealers are simply injected at the surface and transported by the treating fluid. Other than a ball injector, no special or additional treating equipment is required. The ball sealers are designed to have an outer covering sufficiently compliant to seal a jet formed perforation and to have a solid, rigid core which resists extrusion into or through the perforation. Therefore, the ball sealers will not penetrate the formation and permanently damage the flow characteristics of the well.

In the early development of the technology several requirements were repeatedly applied to ball sealers. First, the ball sealers were chemically inert in the environment to which they are exposed. Second, they would seal effectively, yet not extrude into the perforations. Third, the ball sealers would release from the perforations when the pressure differential into the formation is relieved. Fourth, the ball sealers were generally heavier than the wellbore fluid so that they will sink to the bottom of the well, and out of the way, upon completion of the treatment.

Experience also proved that the sealing devices often do not perform effectively because only a fraction of the ball sealers injected actually seat on perforations. Additionally, the practice of using ball sealers having a density greater than the treating fluid yields a low and unpredictable seating efficiency highly dependent on the difference in density between the ball sealers and the fluid, the flow rate of the fluid through the perforations, and the number, spacing and orientation of the perforations. The net result is that the plugging of the desired number of perforations at the proper time during the treatment to effect the desired diversion is left completely to chance.

When these inefficiencies lead to treatment failures, it is generally believed that these failures result from insufficient flow being carried through the perforations, thereby allowing the balls to fall to the bottom of the well without achieving fluid diversion. Attempts to overcome this problem generally include pumping a quantity of balls which exceeds the number of perforations. Although this procedure can be helpful, it has not proven to be a satisfactory solution.

By the late 1970's low density ball sealers were being utilized.

As one example, U.S. Pat. No. 4,102,401, filed Sep. 6, 1977, and issued Jul. 25, 1978, proposes fluid diversion with low density ball sealers. The '401 patent further notes that syntactic foam is a material system comprised of hollow spherical particles dispersed in some form of binder. The commercially available low density syntactic foams which appear to be sufficiently strong to withstand the pressures and temperatures typically encountered by ball sealers, consist of microscopically small, hollow glass spheres (averaging approximately 50 microns in diameter) dispersed in a resin binder such as epoxy. The '401 patent further notes that it is anticipated that in the future it may become possible in syntactic foam systems to use spheres made from materials other than glass and binders made from materials such as thermoplastics and thermosetting plastics. The '401 patent further notes the recent development of high strength glass microspheres which can withstand high pressures of the magnitude typically encountered during injection molding, and concludes that if injection molding can be used to make ball sealers, it will be possible to use a lightweight thermoplastic or thermosetting plastic as the binder resulting in a high strength ball sealer having a very low density. The densities of the ball sealers are taught as being in the range of 0.8 g/cc to 1.1 g/cc.

As another example of low density ball sealers, U.S. Pat. No. 4,244,425, filed May 3, 1979 and issued Jan. 3, 1981, proposes a low density ball sealer for use in well treatment fluid diversions. As described in the '425 patent, The ball sealers themselves must comprise a low density high strength material capable of withstanding the pressures existing within the well. The pressures acting on the ball sealers in the well are the hydrostatic pressure of the fluid in the wellbore and the pumping pressure. The material cannot collapse under the pressures in the well because the decrease in volume of the ball sealer upon collapse will result in a corresponding increase in the density of the ball sealer which can then easily exceed the density of the treating fluid. It has been found that materials that meet the density and compressive strength requirement include syntactic foam and polymethylpentene. Thus, ball sealers comprising syntatic foam or polymethylpentene exhibit both a low density and a high compressive strength. The ball sealers of the present invention are preferably provided with a protective covering. The protective covering may comprise a nonelastomeric plastic material capable of plastic deformation. However, it will be obvious to one skilled in the art that other types of nonplastic protective covering materials such as aluminum may also be utilized in the practice of the present invention.

The following are merely a few of the many patents and patent publications relating to ball sealers.

U.S. Pat. No. 3,895,678 to Wright, et al., issued Jul. 22, 1975, discloses a tool for use with perforation sealer balls utilizes a hollow outer mandrel, a perforated liner, and an elastomeric ball guide and casing seal to channel perforation balls from the casing into a hollow retention mandrel in the lower packer.

U.S. Pat. No. 4,102,401 to Erbstoesser, issued Jul. 25, 1978, discloses low density ball sealers for use as a diverting agent when treating a well having a perforated casing. The ball sealer is sized to plug a perforation and has a density less than the treating fluid. The ball sealer is made of a core material, such as syntactic foam or polymethylpentene, and a covering of a thin layer of an elastomeric material. After some of the treating fluid has been injected into the well, the ball sealers are injected and carried by the fluid flow down to the perforations where they seat and divert the further injection of treating fluid through the remaining open perforations.

U.S. Pat. No. 4,139,060 to Muecke, et al. Feb. 13, 1979, discloses selective wellbore isolation using buoyant ball sealers as a diverting agent when treating a subterranean formation penetrated by a well provided with casing having perforations at a plurality of levels. Ball sealers sized to plug a perforation, a first fluid having a density greater than the ball sealers and a second fluid less dense than the ball sealers are introduced into the casing concurrently or in any order. The amount of the first fluid introduced should be sufficient to fill the lower portion of the casing to a level between the lower perforations to be plugged and the upper perforations to be left open to fluid flow. Once the ball sealers are disposed below the upper perforations, treating fluid is injected into the casing to cause a flow of the second fluid through the lower perforations to carry the ball sealers down the casing to plug the lower perforations and to cause fluid flow through the upper perforation which the ball sealers did not plug.

U.S. Pat. No. 4,187,909 to Erbstoesser, issued Feb. 12, 1980, discloses method and apparatus for placing buoyant ball sealers for diverting fluid when treating a subterranean formation penetrated by a well provided with casing having a plurality of perforations. Ball sealers having a density less than fluid in the casing are lowered down the casing between upper perforations and lower perforations. A screen means is positioned above the ball sealers to prevent upward migration of the balls to a level adjacent the upper perforations. A preferred screen means comprises a cage which is open at its lower end and has openings in its upper end which prevent passage of ball sealers therethrough and permits fluid flow down the casing and through the cage. The cage with the ball sealers therein is lowered down the casing by a conventional wireline. Once the cage and ball sealers are between the upper and lower perforations, a treating fluid more dense than the ball sealers is injected into the well to cause fluid flow. The treating fluid is caused to flow through the screen means to carry the ball sealers down the casing to plug the lower perforations while leaving the upper perforations open to fluid flow.

U.S. Pat. 4,195,690 to Erbstoesser, et al., issued Apr. 1, 1980, discloses a method is disclosed for transporting ball sealers down a perforated casing of a well to affect fluid diversion when hydraulically treating a formation penetrated by the well. In this invention, ball sealers are transported to said perforations in a carrier fluid system comprising a leading fluid portion having a density greater than said ball sealers and a trailing fluid portion having a density less than said ball sealers. The ball sealers will be moved downwardly in the casing to the perforations and will seat onto the perforations through which fluids are flowing to divert fluid through the unplugged perforations.

U.S. Pat. No. 4,244,425 to Erbstoesser, issued Jan. 13, 1981, discloses low density ball sealers for use as a diverting agent when treating a well having a perforated casing. The ball sealer is sized to plug a perforation and has a density less than the treating fluid. The ball sealer comprises a material, such as syntactic foam or polymethylpentene. The ball sealer is also preferably provided with a protective covering material. After some of the treating fluid has been injected into the well, the ball sealers are injected and carried by the fluid flow down to the perforations where they seat and divert the further injection of treating fluid through the remaining open perforations.

U.S. Pat. No. 4,410,387 to Halkerston, et al., issued Oct. 18, 1983, discloses a ball sealer consists of an inner spherical rigid core of a desired density and an outer resilient or compliant continuous layer of uniform thickness which is comprised of a pair of hemispheric caps positioned about and secured to the core and to each other. The ball sealer is formed by molding a first cap in the form of a hemisphere having a central cavity adapted to receive one-half of an inner core. The cap is placed in a cavity in the bottom plate of a mold and the outer surface of an inner core or the inside of the cavity of the cap is coated with an adhesive that will bind the cap to the core. The core is then placed within the cavity of the cap. A cavity plate having a hemispheric cavity is then positioned on top of the bottom plate of the mold with exposed upper half of the inner core received within the cavity of the cavity plate. The second cap is then molded in situ about the inner core and bonded to the first cap and the inner core to form a continuous outer layer of resilient and compliant material encapsulating the inner core.

U.S. Pat. No. 5,485,882 to Bailey, et al., issued Jan. 23, 1996, discloses low-density ball sealer for use as a diverting agent in hostile environment wells. The invention is a rigid, hollow core, low-density ball sealer designed to perform effectively in hostile well environments. It temporarily seals perforations inside cased wells at temperatures up to 400.degree. F. (204.degree. C.), at hydrostatic pressures up to 20,000 psi (137 Mpa), and at differential pressures across the perforations up to 1,500 psi. Ball densities may range from 0.80 to 1.3 gm/cc (or higher). It can withstand the degradation effects of solvents common to oil and gas wells during a workover. Nominal changes in ball density occur during a 24-hour period when exposed to a hostile well environment. The ball sealer is comprised of two pieces made of a high strength material that snap together to form a hollow-core sphere. If necessary, adjustments to ball density can occur subsequent to manufacturing of the ball pieces.

U.S. Patent Application Publication No. 20070169935 published Jul. 26, 2007, and U.S. Pat. No. 7,647,964 issued Jan. 19, 2010, both to Syed Akbr et el., discloses an oil-degradable ball sealer for use in well treatment. The ball seal comprises a particular composition including ethylene and one or more alpha-olefins, prepared by an injection molding technique to provide a ball sealer which will dissolve in stimulation or wellbore fluids after stimulation operations are complete. The composition, when dissolved into wellbore fluids, does not pose a hazard or problem to aqueous wellbore fluids or further wellbore stimulations.

U.S. Patent Application Publication No. 20090255674, published Oct. 15, 2009, and U.S. Pat. No. 8,936,085 issued Jan. 20, 2015, both to Boney et al., disclose that in downhole treatments in the oilfield, ball sealers seated in perforations may not fully seal and may leak fluid through gaps and asperities between the balls and the perforations. A method is given for improving the sealing of ball sealers in perforations by adding a sealing agent that forms a plug in the gaps and severely restricts or eliminates fluid flow. The sealing agent is preferably degradable or soluble, malleable fibers slightly larger than the gaps. Optionally, the particles may be non-degradable, rigid, of different shapes, and smaller than the gaps but able to bridge them. Mixtures of sealing agents may be used. The sealing agent may be added with the ball sealers, after the ball sealers, or both.

U.S. Patent Application Publication No. 20100200235 by Lu et al., published Aug. 12, 2010, discloses degradable perforation balls, compositions, and associated methods of use in subterranean applications that include a method of treating a subterranean formation comprising the steps of providing a carrier fluid comprising degradable balls that comprise a carboxylic acid, a fatty alcohol, a fatty acid salt, a fatty ester, a fatty acid salt, or a combination thereof, and introducing the carrier fluid to the subterranean formation during a treatment.

U.S. Patent Application Publication No. 20150060069, by Potapenko et al., published Mar. 5, 2015, discloses swellable ball sealers comprising swellable material are described. A swellable ball sealer may be used as a diversion agent by being suspended in a fluid injected into a wellbore and swelling once seated on a perforation such that the swellable ball sealer adapts to the shape of a perforation opening on which the swellable ball sealer has seated.

U.S. Patent Application Publication No. 20150129214 by Boney et al., published May 14, 2015, discloses that in downhole treatments in the oilfield, ball sealers seated in perforations may not fully seal and may leak fluid through gaps and asperities between the balls and the perforations. A method is given for improving the sealing of ball sealers in perforations by adding a sealing agent that forms a plug in the gaps and severely restricts or eliminates fluid flow. The sealing agent is preferably degradable or soluble, malleable fibers slightly larger than the gaps. Optionally, the particles may be non-degradable, rigid, of different shapes, and smaller than the gaps but able to bridge them. Mixtures of sealing agents may be used. The sealing agent may be added with the ball sealers, after the ball sealers, or both.

U.S. Patent Application Publication No. 20150354311 by Okura et al., published Dec. 10, 2015, discloses a poly-L-lactic acid (PLLA) solid-state extrusion molded article having a weight average molecular weight of from 100,000 to 380,000 and a melt viscosity of from 20 to 2,000 Pas (at a temperature of 240.degree. C. and a shear rate of 120 sec.sup.−1) and having an L-form content of from 80 to 100%, the article having a thickness or diameter of from 10 to 500 mm and a tensile strength of from 5 to 100 MPa at a temperature of 66.degree. C. (the article may contain a filler and have a tensile strength of from 5 to 200 MPa); a downhole tool member or a ball sealer for well drilling and completion formed by machining the solid-state extrusion molded article; an isolation plug provided with the downhole tool member; and a production method for a PLLA solid-state extrusion molded article comprising steps of supplying a resin material containing a PLLA to an extruder, solid-state extrusion molding the material, pressurizing the solid-state extrusion molded product, drawing the pressurized product while applying a back pressure in the direction of a forming die to suppress the expansion of the solid-state extrusion molded product; and a well drilling and completion method.

In spite of the advancements in the ball sealer art, there is still the need for improved ball sealers, and methods of making and using same.

There is also a need in the art for improved low density ball sealers, and methods of making and using same.

There is even also a need in the art for improved low density water soluble ball sealers and methods of making and using same.

These and other needs in the art will become apparent to those of skill in the art upon review of this specification, including its drawings and claims.

### SUMMARY OF THE INVENTION

It is an object of the present invention to provide for improved low density ball sealers, and methods of making and using same.

It is another object of the present invention to provide for improved low density water soluble ball sealers and methods of making and using same.

These and other objects will become apparent to those of skill in the art upon review of this specification, including its drawings and claims.

According to one embodiment of the present invention, there is provide a ball sealer for plugging perforations in a wellbore. The ball sealer includes a first solid phase comprising a water soluble polymer phase having a generally spherical shape; and includes a second solid phase comprising microspheres and residing in the first phase. In further sub-embodiments of this embodiment, the ball sealer has a diameter in the range of about ⅓ inches to about 2 inches; the water soluble polymer is selected from the group consisting of water soluble polyvinyl acetate, polyamines, polyamides, polyacrylics, polyvinyl alcohol, polyvinylpyrrolidone, polyethylenimine, polydimethylsiloxane, and mixtures of and copolymers of any two or more of the foregoing; the microspheres are selected from the group consisting of ceramic microspheres, glass microspheres, polymer microspheres, and metal microspheres; the microspheres comprise a diameter in the range between 0.1 and 1000 μm in size; and/or the ball sealer has a diameter in the range of about ⅖ inches to about 1½ inches; wherein the water soluble polymer comprises polyvinyl acetate; wherein the microspheres comprise glass microspheres; and wherein the microspheres comprise a diameter in the range between 0.1 and 1000 μm in size.

According to another embodiment of the present invention, there is provided a method of sealing a perforation in a wellbore, with the wellbore having a well fluid residing therein having a fluid density. The method may include injecting into the wellbore a ball sealer suspended in a fluid to a region of the perforation, wherein the ball sealer has a density less than the fluid density and comprises a first solid phase comprising a water soluble phase having a generally spherical shape, and comprises a second solid phase comprising microspheres and residing in the first phase. The method may also include applying pressure to in the wellbore sufficient to seal the ball sealer on the perforation. In further sub-embodiments of this embodiment, the ball sealer has a diameter in the range of about ⅓ inches to about 2 inches; the water soluble polymer is selected from the group consisting of water soluble polyvinyl acetate, polyamines, polyamides, polyacrylics, polyvinyl alcohol, polyvinylpyrrolidone, polyethylenimine, polydimethylsiloxane, and mixtures of and copolymers of any two or more of the foregoing; the microspheres are selected from the group consisting of ceramic microspheres, glass microspheres, polymer microspheres, and metal microspheres; the microspheres comprise a diameter in the range between 0.1 and 1000 μm in size; and/or the ball sealer has a diameter in the range of about ⅖ inches to about 1½ inches; wherein the water soluble polymer comprises polyvinyl acetate; wherein the microspheres comprise glass microspheres; and wherein the microspheres comprise a diameter in the range between 0.1 and 1000 μm in size.

These and other embodiments of the present invention will become apparent to those of skill in the art upon review of this specification, including its drawings and claims.

### DETAILED DESCRIPTION OF THE INVENTION

The present invention provides for ball sealers, and to methods of making and using ball sealers.

The ball sealers of the present invention will comprise a water soluble polymer phase, and further comprise a low density phase that is incorporated into the polymer phase, such that the ball sealer comprises a distinct polymer phase and one or more distinct low density phases.

The ball sealers of the present invention will have specific gravities less than the well treating fluid. Since fluids used for treating wells quite commonly have specific gravities in the range of 0.8 to 1.1 (and even below and above this range), the low density ball sealers will have specific gravities in the same range. The ball sealers of the present invention will generally have a specific gravity equal to 1.1, 1.0, 0.9, 0.8, 0.7, 0.6 or 0.5, or less than 1.1, 1.0, 0.9, 0.8, 0.7, 0.6 or 0.5, or in a range to/from any two of the prior specific gravities, or in a range between any two of the prior specific gravities.

As the polymer utilized in the polymer phase will generally have a specific gravity greater than 1.1, a material having a specific gravity less than 1.1 is utilized for the low density phase. Accordingly, the weight ratio of the polymer phase to the low density phase is selected to achieve the desired specific gravity of the produced ball sealer.

In the practice of the present invention, the ball sealers of the present invention are generally spherical in shape, and have a diameter that will be sufficient such that a single ball sealer will suffice to plug perforations that have been formed in the subterranean formation by the perforation operation. Commercially, the smallest perforations average about 0.4 inches, and can certainly be larger. It is not usual to find ball sealers having diameters of ⅝ inches, ⅞ inches, 1⅓ inches or even larger. In the practice of the present invention, the ball sealers will have a diameter of ⅓ inches, ⅖ inches, ½ inches, ⅔ inches, ¾ inches, ⅞ inches, 1 inch, 1⅛ inches, 1¼ inches, 1½ inches, 1 and ½ inches, 2 inches, or 5 inches, or in a range to/from any two of the prior listed diameters, or in a range between any two of the prior listed diameters.

The polymers useful for the water soluble polymer phase will include water soluble polyvinyl acetate, polyamines, polyamides, polyacrylics, polyvinyl alcohol, polyvinylpyrrolidone, polyethylenimine, polydimethylsiloxane, and mixtures of and copolymers of any two or more of the foregoing. Non-limiting embodiments of the present invention will utilize a polyvinyl acetate that may or may not be hydrolyzed. For certain non-limiting embodiments, the hydrolysis may be up to about 50, 55, 60, 65, 70, 75, 80, 85, 90, or 96 weight percent, or the hydrolysis may be in a range to/from or between any two of the prior weight percentages. Certain non-limiting embodiments of the present invention utilize a polyvinyl acetate with 85 to 96 weight percent hydrolysis.

Broadly speaking, the polymers useful in the present invention will have a molecular weight in the range of about 800 to about 500,000 Daltons. Generally, polymers of the present invention will have a molecular weight in a range starting at 800, 1000, 2000, 3000, 4000 or 5000 Daltons and ending at 100000, 200000, 300000, 400000 or 500000 Daltons. As solubility decreases with increasing molecular weight, the upper limiting for molecular weight will be where the polymer no longer has sufficient water solubility, and that molecular will vary for each type of polymer.

In the practice of the present invention, the low density phase may comprise any suitable material that will provide the combined material with suitable density and strength to be employed as a ball sealer. In certain non-limiting embodiments, the low density phase will comprise micro-particles, more specifically microspheres, and even more specifically glass microspheres. In the present invention, micro-particles should be understood as particles to/from or between 0.1 and 1000 μm in size. Commercially available micro-particles are available in a wide variety of materials, including ceramics, glass, polymers, and metals, and all are believed to be suitable for use in the present invention. Suitable commercially available microspheres may be obtained from a number of producers including 3M, Potters, Prizmalite and others. Certain non-limiting embodiments of the present invention will utilize microspheres with specific gravities in the range of about 0.35 to about 0.38, but certainly, microspheres with higher or lower specific gravities may be employed.

The ball sealers of the present invention may be formed by any suitable manufacturing technique known in the plastic arts. Most commonly that will include injection molding. Generally, the water soluble polymer and the microspheres are mixed together, subjected to sufficient heat, and then injected molded into the desired form, generally spherical, and allowed to cool and harden. Some embodiments of the present invention include further covering this formed spherical shape with another water soluble coating. Other embodiments of the present invention include using this polymer/microsphere mixture as the only coating or one of the coatings around a spherical inner core to form a ball sealer.

It is generally believed that the crush strength of the ball sealer is mainly provided by the polymer phase, however, it is generally suggested to also make sure that the low density material has sufficient crush strength. Generally, certain non-limiting embodiments of the present invention utilize microspheres having a crush strength of at least 1000 psi, 2500 psi, 5000 psi, 10000 psi, or 15000 psi.

Finally, all articles, books, information, journals, magazines, materials, newsletters, newsletters, online materials, patent applications, patent publications, periodicals, publications, texts, and treatises, and/or any other type of publication, cited in this application are herein incorporated by reference in their entirety as if each individual reference was specifically and individually set forth herein. It should be understood that incorporated information is as much a part of the application as filed as if the information was repeated in the application, and should be treated as part of the text of the application as filed.

While the present invention has been described as being useful for creating a bonded friction course pavement, it should be understood that the compositions, products and methods of the present invention may be useful in any form of pavement not just bonded friction course pavement. The present invention may find utility for any type of asphalt application such as roads, runways, athletic tracks, speedway tracks, parking lots, roofing surfaces, driveways, playground surfaces, sports surfaces, and the like, be it as the top surface layer, or as a below surface layer. The present invention may also be useful for creating a water-proof barrier between zones or around certain objects.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

1. A ball sealer for plugging perforations in a wellbore, the ball sealer comprising:
a first solid phase comprising a water soluble polymer phase having a generally spherical shape; and,
a second solid phase comprising microspheres and residing in the first phase.

2. The ball sealer of claim 1, wherein the ball sealer has a diameter in the range of about ⅓ inches to about 2 inches.

3. The ball sealer of claim 1, wherein the water soluble polymer is selected from the group consisting of water soluble polyvinyl acetate, polyamines, polyamides, polyacrylics, polyvinyl alcohol, polyvinylpyrrolidone, polyethylenimine, polydimethylsiloxane, and mixtures of and copolymers of any two or more of the foregoing

4. The ball sealer of claim 1, wherein the microspheres are selected from the group consisting of ceramic microspheres, glass microspheres, polymer microspheres, and metal microspheres.

5. The ball sealer of claim 1, wherein the microspheres comprise a diameter in the range between 0.1 and 1000 μm in size.

6. The ball sealer of claim 1, wherein the ball sealer has a diameter in the range of about ⅖ inches to about 1½ inches; wherein the water soluble polymer comprises polyvinyl acetate; wherein the microspheres comprise glass microspheres; and wherein the microspheres comprise a diameter in the range between 0.1 and 1000 μm in size.

7. A method of sealing a perforation in a wellbore, with the wellbore having a well fluid residing therein having a fluid density, the method comprising:
injecting into the wellbore a ball sealer suspended in a fluid to a region of the perforation, wherein the ball sealer has a density less than the fluid density and comprises a first solid phase comprising a water soluble phase having a generally spherical shape, and comprises a second solid phase comprising microspheres and residing in the first phase; and,
applying pressure to in the wellbore sufficient to seal the ball sealer on the perforation.

8. The method of claim 7, wherein the ball sealer has a diameter in the range of about ⅓ inches to about 2 inches.

9. The method of claim 7, wherein the water soluble polymer is selected from the group consisting of water soluble polyvinyl acetate, polyamines, polyamides, polyacrylics, polyvinyl alcohol, polyvinylpyrrolidone, polyethylenimine, polydimethylsiloxane, and mixtures of and copolymers of any two or more of the foregoing.

10. The method of claim 7, wherein the microspheres are selected from the group consisting of ceramic microspheres, glass microspheres, polymer microspheres, and metal microspheres.

11. The method of claim 7, wherein the microspheres comprise a diameter in the range between 0.1 and 1000 μm in size.

12. The method of claim 7, wherein the ball sealer has a diameter in the range of about ⅖ inches to about 1½ inches; wherein the water soluble polymer comprises polyvinyl acetate; wherein the microspheres comprise glass microspheres; and wherein the microspheres comprise a diameter in the range between 0.1 and 1000 μm in size.
